(19) United States
(12) Patent Application Publication
(10) Pub. No.: US 2007/0078651 A1
(43) Pub. Date: Apr. 5, 2007

(54) Device and method for encoding, decoding speech and audio signal

(75) Inventors: Dohyung Kim, Hwaseong-si (KR); Miyoung Kim, Suwon-si (KR); Shihwa Lee, Seoul (KR); Sangwook Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/527,550

(22) Filed: Sep. 27, 2006

(30) Foreign Application Priority Data
Sep. 29, 2005 (KR) 10-2005-0091190

(51) Int. Cl. G10L 19/02

(52) U.S. Cl. 704/229

(57) ABSTRACT

A device and method for encoding/decoding a speech signal and an audio signal. The device for encoding the speech signal and the audio signal includes a speech encoding unit which speech-encodes an input signal; an speech decoding unit which speech-decodes the speech-encoded signal; and an audio encoding unit which divides a difference signal between the speech-decoded signal and the input signal into a low band and a high band, allocates the number of bits to the divided bands, and audio-encodes the difference signal.

### CROSS-REFERENCE TO RELATED APPLICATION

This application claims the benefit of Korean Patent Application No. 10-2005-0091190, filed on Sep. 29, 2005, in the Korean Intellectual Property Office, the disclosure of which is incorporated herein by reference.

### BACKGROUND OF THE INVENTION

1. Field of the Invention

The present invention relates to encoding and decoding of a speech signal and an audio signal, and more particularly, to a device and method for encoding a speech signal and an audio signal and a device and method for decoding a speech signal and an audio signal.

2. Description of Related Art

An audio signal is a continuous analog signal in time. Accordingly, analog/digital (A/D) conversion is required for representing a waveform with a discrete signal. For the A/D conversion, it is necessary to perform a sampling process for converting a continuous-time signal into a discrete signal and an amplitude quantizing process for limiting the amplitude values to a finite value. With the recent advances in digital signal processing technologies, a method of converting an analog signal into pulse code modulation (PCM) data through sampling and quantizing processes, storing the signal in a record/storage medium such as a compact disc (CD) or a digital audio tape (DAT), and allowing a user to play the stored signal if necessary has been frequently used. Such a digital storing/restoring method is superior to an analog method, such as long-play record or tape, in view of sound quality and storage period. However, since the size of the digital data is large, the digital method brings with it difficulties in the storage and transmission of the data.

In order to solve this problem, the amount of the data must be reduced. Several known methods such as differential pulse code modulation (DPCM) or adaptive differential pulse code modulation (ADPCM) have thus been developed for compressing a digital audio signal. However, in this case, the efficiency in reducing the amount of the data varies depending on the kind of the signal.

Recently, in a moving pictures expert group (MPEG)/audio method standardized by the International Standard Organization (ISO) or an AC-2/AC-3 method developed by Dolby Laboratories, Inc., a method of reducing the amount of the data using a human psychoacoustic model has been used. These methods can efficiently reduce the amount of the data regardless of the characteristics of the signal.

In existing audio signal compressing methods such as MPEG-1/audio, MPEG-2/audio or AC-2/AC-3, a signal in the time domain is grouped into blocks having a regular size and converted into a signal in the frequency domain. Then, the converted signal is scalar-quantized using the human psychoacoustic model. Thereafter, lossless encoding such as entropy encoding is performed. Accordingly, a more complicated process is performed compared with a method of merely storing only the PCM data, and a bit stream is composed of quantized PCM data and additional information for compressing a signal.

The MPEG/audio standard or AC-2/AC-3 method provides substantially the same sound quality as that of a compact disc, with a bit number of 64 Kbps to 384 Kbps, which is less than that of the existing digital encoding method by ⅙ or ⅛. Accordingly, the MPEG/audio standard performs an important role in storing and transmitting an audio signal in a multimedia system such as digital audio broadcasting (DAB), Internet phone, and audio on demand (AOD). Among audio signals, an audio signal generated by human utterance is referred to as a speech signal.

In the speech signal, a main audio component has a human audio frequency in a low frequency band. Thus, the speech signal must be encoded/decoded using an encoding/decoding method different from that of a general (non-speech) audio signal.

A frame process unit of the speech signal is not a multiple of 2. For example, the frame process unit of the speech signal has generally 320 samples. However, for high-speed implementation, the frame process unit of the speech signal must be a multiple of 2. For example, the frame process unit of the general audio signal has generally 256 samples, which is a multiple of 2. Accordingly, when the speech signal is input, a component of a codec for encoding both the speech signal and the audio signal must include a component which performs down-sampling for making the frame process unit of the speech signal a multiple of 2.

Furthermore, a component of a codec for decoding both the speech signal and the audio signal must include a component which performs up-sampling for returning the frame process unit of the speech signal to an original process unit, and a high frequency generating unit which restores a high frequency band signal which is removed upon the down-sampling of the encoding process.

Accordingly, in the conventional art, in order to realize a device for encoding and decoding both the speech signal and the audio signal, many components must be used, and thus, the structural complexity of the device increases.

### BRIEF SUMMARY

An aspect of the present invention provides a device for encoding and decoding a speech signal and an audio signal using an adaptive bit number.

An aspect of the present invention also provides a method for encoding and decoding a speech signal and an audio signal using an adaptive bit number.

According to an aspect of the present invention, there is provided a device for encoding a speech signal and a non-speech audio signal, including: a speech encoding unit which speech-encodes an input signal; an speech decoding unit which speech-decodes the speech-encoded signal; and an audio encoding unit which divides a difference signal between the speech-decoded signal and the input signal into a low band and a high band, allocates the number of bits to the divided bands, and audio-encodes the difference signal.

According to another aspect of the present invention, there is provided a device for decoding a speech signal and a non-speech audio signal including: an audio decoding unit which audio-decodes audio-encoded signals to which the number of bits are allocated according to a low band and high band; and a speech decoding unit which speech-decodes a speech-encoded signal.

According to another aspect of the present invention, there is provided a method for encoding a speech signal and a non-speech audio signal including: speech-encoding an input signal; speech-decoding the speech-encoded signal; and dividing a difference signal between the speech-decoded signal and the input signal into a low band and a high band, allocating the number of bits to the divided bands, respectively, and audio-encoding the difference signal.

According to another aspect of the present invention, there is provided a method for decoding a speech signal and a non-speech audio signal including: audio-decoding audio-encoded signals to which the number of bits are allocated according to a low band and high band; and speech-decoding a speech-encoded signal.

According to another aspect of the present invention, there is provided a device for encoding a speech signal and a non-speech audio signal, including: an audio encoding unit which divides a difference signal between an input signal and a speech-decoded signal into a low band and a high band, allocates the number of bits to the divided bands, and audio-encodes the difference signal. The speech-decoded signal is a decoded speech-encoded signal, and the speech-encoded signal is a speech-encoded version of the input signal.

According to another aspect of the present invention, there are provided computer-readable media encoded with processing instructions for causing a processor to execute the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a device for encoding a speech signal and an audio signal according to an embodiment of the present invention;

FIG. 2 is a block diagram of the audio encoding unit illustrated in FIG. 1;

FIG. 3 illustrates an example of an audio signal which is converted into sub-bands in a frequency domain by a sub-band analysis filter illustrated in FIG. 2;

FIG. 4 is a block diagram of a device for decoding a speech signal and an audio signal according to an embodiment of the present invention;

FIG. 5 is a block diagram of the audio decoding unit illustrated in FIG. 4;

FIG. 6 is a flowchart illustrating a method of encoding a speech signal and an audio signal according to an embodiment of the present invention;

FIG. 7 is a flowchart illustrating operation 504 illustrated in FIG. 6;

FIG. 8 is a flowchart illustrating a method of decoding a speech signal and an audio signal according to an embodiment of the present invention; and

FIG. 9 is a flowchart illustrating operation 700 illustrated in FIG. 8.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a device for encoding a speech signal and an audio signal according to an embodiment of the present invention will be described with reference to accompanying drawings.

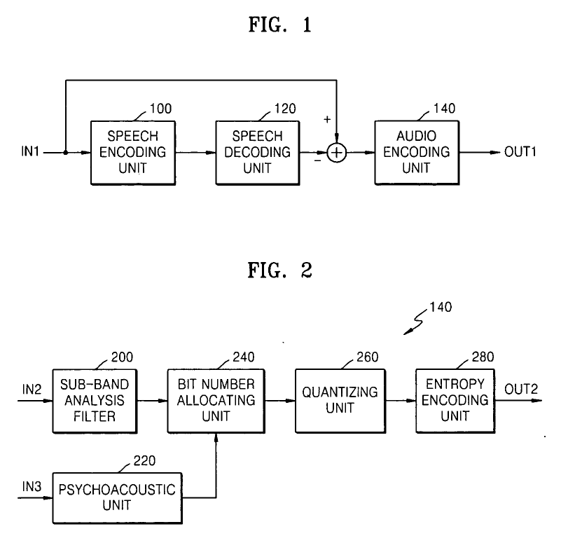

FIG. 1 is a block diagram of a device for encoding a speech signal and an audio signal according to an embodiment of the present invention. The encoding device includes a speech encoding unit 100, a speech decoding unit 120, and an audio encoding unit 140.

First, the speech encoding unit 100 speech-encodes a signal input through an input terminal IN1 and outputs the encoded result to the speech decoding unit 120. The speech encoding unit 100 is, for example, a G.729 codec. The G.729 codec uses a method of compressing a signal of 64 Kbps into 8 Kbps according to conjugate structure-algebraic code excited linear prediction (CS-ACELP).

The speech decoding unit 120 decodes the speech-encoded signal output from the speech encoding unit 100, and outputs the decoded result to the audio encoding unit 140. For example, the speech decoding unit 120 decodes the signal which is encoded by the G.729 codec.

The audio encoding unit 140 divides a difference signal between the speech-decoded signal output from the speech decoding unit 120 and the input signal input to the speech encoding unit 100 into a low band and a high band, respectively allocates the number of bits to the divided bands, audio-encodes the difference signal, and outputs the encoded result through an output terminal OUT1.

FIG. 2 is a block diagram of the audio encoding unit illustrated in FIG. 1. The audio encoding unit includes a sub-band analysis filter 200, a psychoacoustic model unit 220, a bit number allocating unit 240, and a quantizing unit 260, and an entropy encoding unit 280.

The sub-band analysis filter 200 receives the difference signal through an input terminal IN2.

The sub-band analysis filter 200 converts the input difference signal into a predetermined number of signals having sub-bands in a frequency domain and outputs the converted results to the bit number allocating unit 240.

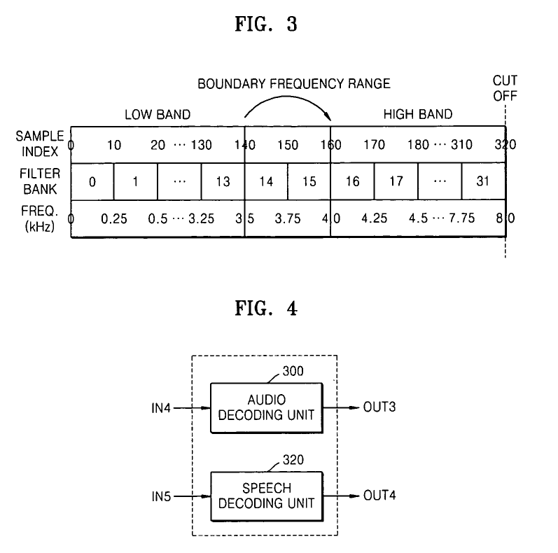

FIG. 3 illustrates an example of an audio signal which is converted into signals having the sub-bands in the frequency domain by the sub-band analysis filter illustrated in FIG. 2.

As illustrated in FIG. 3, an 8 kHz signal of which a frame process unit has 320 samples is converted into the signal having 32 sub-bands in the frequency domain. As such, the sub-band analysis filter 200 converts the input signal, of which the frame process unit is not a multiple of 2, into a predetermined number, for example, 32, of signals in the frequency domain.

The psychoacoustic model unit 220 receives a signal through an input terminal IN3, calculates masking thresholds of the sub-bands output from the sub-band analysis filter 200 using the input signal, and outputs the calculated results to the bit number allocating unit 240. The masking threshold is a limit value which is usable to detect an original sound from a curve of an original sound and a minimum audible limit in psychoacoustic encoding.

The bit number allocating unit 240 groups the converted audio signals into the high-band and the low band, allocates a low-band bit number and a high-band bit number to the low band and the high band, respectively, and outputs the allocated results to the quantizing unit 260.

The bit number allocating unit 240 groups the converted signals into the low band and the high band. A boundary frequency for defining the low band and the high band may be previously set. For example, as illustrated in FIG. 3, in the audio signal having the frequency band of 8 kHz, any one frequency in a range of 3.5 to 4.0 kHz may be set as the boundary frequency for defining the low band and the high band. The converted signals are grouped into the low band and high band based on the boundary frequency.

An allocation bit number for encoding the low band signal is the low-band bit number and an allocation bit number for encoding the high band signal is the high-band bit number.

The bit number allocating unit 240 calculates the low-band bit number using Equation 1 and calculates the high-band bit number using Equation 2, as follows:
B_{LB}=B_{T}×T_{LB}/(T_{LB}+T_{HB}); Equation 1 and
B_{HB}=B_{T}×T_{HB}/(T_{LB}+T_{HB}). Equation 2
Here, B_{LB} denotes the low-band bit number, B_{HB} denotes the high-band bit number, B_{T} denotes a total bit number allocated to the entire band, T_{LB} denotes an average value of the masking thresholds of the sub-bands included in the low band, and T_{HB} denotes an average value of the masking thresholds of the sub-bands included in the high band.

The total bit number allocated to the entire band is a total bit number allocated when encoding the signal converted into the frequency domain in the entire band.

The average value of the masking thresholds of the sub-bands included in the low band is obtained by averaging the masking thresholds of the sub-bands included in the low band among the masking thresholds obtained by the psychoacoustic model unit 220.

The average value of the masking thresholds of the sub-bands included in the high band is obtained by averaging the masking thresholds of the sub-bands included in the high band among the masking thresholds obtained by the psychoacoustic model unit 220.

The bit number allocating unit 240 allocates a higher bit number to the high band than to the low band in a case of the speech signal, and allocates a higher bit number to the low band than to the high band in a case of the audio signal.

The bit number allocating unit 240 allocates the number of bits to the sub-bands included in the low band in the range of the low-band bit number obtained by Equation 1. At this time, the bit number allocating unit 240 allocates the number of bits to the sub-bands using the corresponding thresholds obtained by the psychoacoustic model unit 220.

For example, when the high-band bit number is 800 bits, the bit number is allocated to the sub-bands included in the low band by the respective thresholds in the range of 800 bits. The larger the threshold of the sub-band, the larger bit number is allocated. The smaller the threshold of the sub-band, the smaller bit number is allocated.

Furthermore, the bit number allocating unit 240 allocates the number of bits to the sub-bands included in the high band in the range of the high-band bit number obtained by Equation 2. At this time, the bit number allocating unit 240 allocates the number of bits to the sub-bands using the corresponding thresholds obtained by the psychoacoustic model unit 220.

For example, when the low-band bit number is 200 bits, the number of bits is allocated to the sub-bands included in the high band by the respective thresholds in the range of 800 bits. When the threshold of the sub-band is larger, the larger bit number is allocated. When the threshold of the sub-band is smaller, the smaller bit number is allocated.

The quantizing unit 260 quantizes the audio signals converted by the sub-band analysis filter 200 according to the low-band bit number and the high-band bit number and outputs the quantized results to the entropy encoding unit 280. The quantizing unit 260 quantizes the audio signals by the sub-band according to the bit number allocated to each sub-band.

The entropy encoding unit 280 encodes the quantized audio signals and outputs the encoded results through an output terminal OUT2.

Hereinafter, a device for decoding a speech signal and an audio signal according to an embodiment of the present invention will be described with reference to accompanying drawings.

FIG. 4 is a block diagram of a device for decoding a speech signal and an audio signal according to an embodiment of the present invention. The decoding device includes an audio decoding unit 300 and a speech decoding unit 320.

The audio decoding unit 300 receives audio-encoded signals through an input terminal IN4, audio-decodes the audio-encoded signals to which the number of bits are allocated according to a low band and a high band, and outputs the decoded results through an output terminal OUT3.

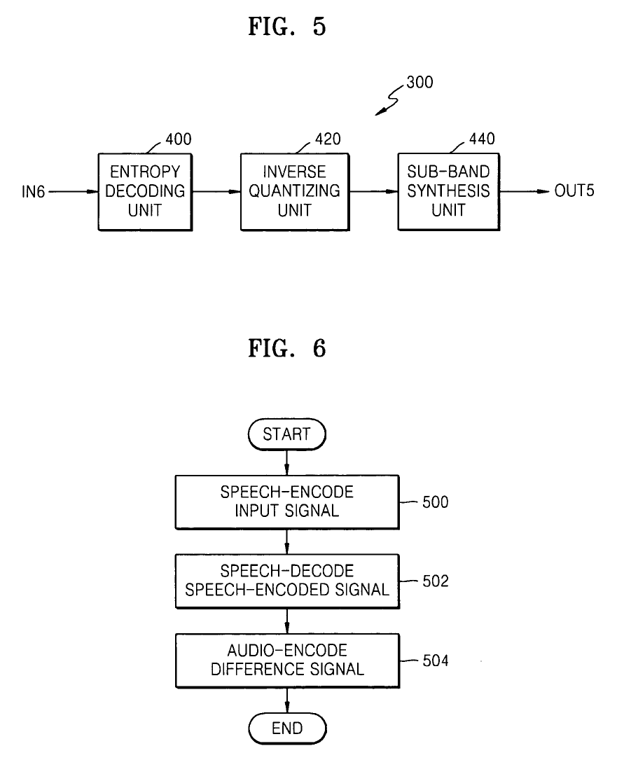

FIG. 5 is a block diagram of the audio decoding unit illustrated in FIG. 4. The audio decoding unit 300 includes an entropy decoding unit 400, an inverse quantizing unit 420, and a sub-band synthesis filter 440.

The entropy decoding unit 400 receives the audio-encoded signals through an input terminal IN6, audio-decodes the audio-encoded signals, and outputs the decoded results to the inverse quantizing unit 420.

The inverse quantizing unit 420 inversely quantizes the audio-decoded signals according to a low-band bit number allocated to the low band and a high-band bit number allocated to the high band, and outputs the inversely quantized results to the sub-band synthesis filter 440.

The inverse quantizing unit 420 inversely quantizes the audio signals in the low band according to the number of bits allocated to the sub-bands in the low band in the range of the low-band bit number. Furthermore, the inversely quantizing unit 420 inversely quantizes the audio signals in the high band according to the number of bits allocated to the sub-bands in the high band in the range of the high-band bit number.

The low-band bit number is calculated by Equation 1 and the high-band bit number is calculated by Equation 2.

The sub-band synthesis filter 440 converts the inversely quantized audio signals into a time domain and outputs the converted result through an output terminal OUT5.

The speech decoding unit 320 receives the speech-encoded signal output from a speech encoding unit through an input terminal IN5, speech-decodes the speech-encoded signal, and outputs the decoded result through an output terminal OUT4.

The audio-decoded signal output from the audio decoding unit 300 and the speech-decoded signal output from the speech decoding unit 320 are synthesized and output as a final audio signal.

Hereinafter, a method of encoding a speech signal and an audio signal according to an embodiment of the present invention will be described with reference to accompanying drawings.

FIG. 6 is a flowchart illustrating a method of encoding a speech signal and an audio signal according to an embodiment of the present invention.

An input signal is speech-encoded (operation 500).

After operation 500, the speech-encoded signal is speech-decoded (operation 502).

After operation 502, a difference signal between the speech-decoded signal and the input signal is divided into a low band and a high band, the number of bits are allocated to the divided bands, and the difference signal is audio-encoded (operation 504).

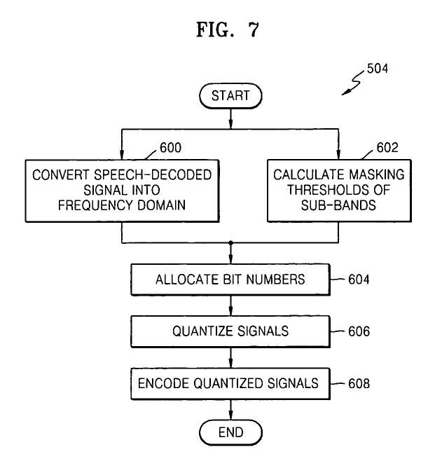

FIG. 7 is a flowchart illustrating in detail operation 504 illustrated in FIG. 6.

In operation 504, the speech-decoded signal is converted into a predetermined number of sub-bands in a frequency domain (operation 600). As illustrated in FIG. 3, the input signal, of which the frame process unit is not a multiple of 2, is converted into a predetermined number, for example, 32, of signals in the frequency domain.

Masking thresholds of the sub-bands are calculated (operation 602). The masking threshold is a limit value which can be used to detect an original sound from a curve of an original sound and a minimum audible limit in psychoacoustic encoding.

After operations 600 and 602, the converted signals are grouped into the low band and the high band, and a low-band bit number and a high-band bit number are allocated to the low band and the high band, respectively (operation 604).

An allocation bit number for encoding the low band signal is the low-band bit number and an allocation bit number for encoding the high band signal is the high-band bit number.

The low-band bit number is calculated using Equation 1 and the high-band bit number is calculated using Equation 2.

In a case of the speech signal, a larger bit number is allocated to the high band than to the low band and, in a case of a non-speech audio signal, a larger bit number is allocated to the low band than to the high band.

The number of bits is allocated to the sub-bands included in the low band in the range of the low-band bit number obtained by Equation 1. At this time, the number of bits is allocated to the sub-bands using the corresponding thresholds obtained in operation 602.

The number of bits is allocated to the sub-bands included in the high band in the range of the high-band bit number obtained by Equation 2. At this time, the number of bits is allocated to the sub-bands using the corresponding thresholds obtained in operation 602.

After operation 604, the converted signals are quantized according to the allocated low-band bit number and the allocated high-band bit number (operation 606). That is, the audio signals are quantized by the sub-band according to the bit number allocated to each sub-band.

After operation 606, the quantized audio signals are encoded (operation 608).

Hereinafter, a method of decoding a speech signal and an audio signal according to an embodiment of the present invention will be described with reference to accompanying drawings.

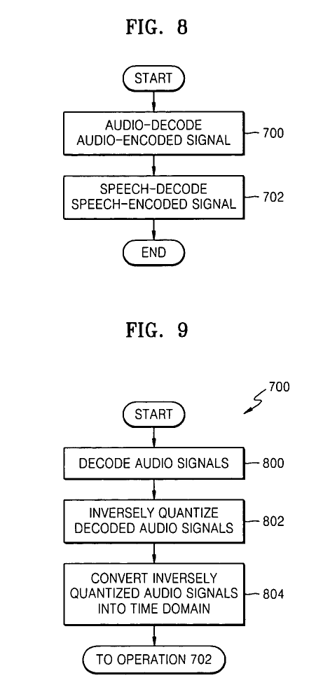

FIG. 8 is a flowchart illustrating a method for decoding a speech signal and an audio signal according to an embodiment of the present invention.

Audio-encoded signals are audio-decoded (operation 700).

FIG. 9 is a flowchart illustrating in detail operation 700 illustrated in FIG. 8.

In operation 700, the audio-encoded signals are decoded (operation 800).

After operation 800, the decoded audio signals are inversely quantized according a low-band bit number allocated to a low band and the high-band bit number allocated to a high band (operation 802).

The low-band bit number is calculated using Equation 1 and the high-band bit number is calculated using Equation 2.

The audio signals in the low band are inversely quantized according to the number of bits allocated to the sub-bands in the low band in the range of the low-band bit number and the audio signals in the high band are inversely quantized according to the number of bits allocated to the sub-bands in the high band in the range of the high-band bit number.

After operation 802, the inversely quantized audio signals are converted into a time domain (operation 804).

After operation 700, the speech-encoded signal is speech-decoded (operation 720).

Embodiments of the present invention include computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network coupled computer systems so that the computer readable code is stored and executed in a distributed fashion.

According to the device and method for encoding the speech signal and the audio signal and the device and method for decoding the speech signal and the audio signal of the above-described embodiments of the present invention, since the speech signal and the audio signal are encoded using an adaptive bit number, it is possible to encode and decode both the audio signal and the speech signal with high quality.

According to the device and method for encoding the speech signal and the audio signal and the device and method for decoding the speech signal and the audio signal of the above-described embodiments of the present invention, although the frame process unit of the audio signal is not a multiple of 2, it is possible to accomplish high-quality encoding and decoding.

According to the device and method for encoding the speech signal and the audio signal and the device and method for decoding the speech signal and the audio signal of the above-described embodiments of the present invention, it is possible to accomplish high-quality encoding and decoding while reducing the complexity of the device for encoding and decoding the speech signal and the audio signal.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A device for encoding a speech signal and a non-speech audio signal, comprising:
a speech encoding unit which speech-encodes an input signal;
an speech decoding unit which speech-decodes the speech-encoded signal; and
an audio encoding unit which divides a difference signal between the speech-decoded signal and the input signal into a low band and a high band, allocates the number of bits to the divided bands, and audio-encodes the difference signal.

2. The device of claim 1, wherein the audio encoding unit comprises:
a sub-band analysis filter which converts the difference signal into a predetermined number of signals having sub-bands in a frequency domain;
a psychoacoustic model unit which calculates masking thresholds of the sub-bands of the converted signals;
a bit number allocating unit which groups the converted signals into the low band and the high band and allocates a low-band bit number and a high-band bit number to the low band and the high band, respectively;
a quantizing unit which quantizes the converted signals according to the low-band bit number and the high-band bit number; and
an entropy encoding unit which encodes the quantized signals.

3. The device of claim 2, wherein the bit number allocating unit calculates the low-band bit number using the following equation
B_{LB}=B_{T}×T_{LB}/(T_{LB}+T_{HB}), and
wherein, B_{LB} denotes the low-band bit number, B_{T} denotes a total bit number allocated to the entire band, T_{LB} denotes an average value of the masking thresholds of the sub-bands included in the low band, and T_{HB} denotes an average value of the masking thresholds of the sub-bands included in the high band.

4. The device of claim 3, wherein the bit number allocating unit allocates the number of bits to the sub-bands included in the low band in the range of the low-band bit number using corresponding thresholds.

5. The device of claim 2, wherein the bit number allocating unit calculates the high-band bit number using the following equation
B_{HB}=B_{T}×T_{HB}/(T_{LB}+T_{HB}), and
wherein, B_{HB} denotes the high-band bit number, B_{T} denotes a total bit number allocated to the entire band, T_{LB} denotes an average value of the masking thresholds of the sub-bands included in the low band, and T_{HB} denotes an average value of the masking thresholds of the sub-bands included in the high band.

6. The device of claim 5, wherein the bit number allocating unit allocates the number of bits to the sub-bands included in the high band in the range of the high-band bit number using corresponding thresholds.

7. A device for decoding a speech signal and a non-speech audio signal, comprising:
an audio decoding unit which audio-decodes audio-encoded signals to which the number of bits are allocated according to a low band and high band; and
a speech decoding unit which speech-decodes a speech-encoded signal.

8. The device of claim 7, wherein the audio decoding unit comprises:
an entropy decoding unit which decodes the audio-encoded signal;
an inverse quantizing unit which inversely quantizes the decoded audio signal according to a low-band bit number allocated to the low band and a high-band bit number allocated to the high band; and
a sub-band synthesis filter which converts the inversely quantized audio signal into an audio signal of a time domain.

9. A method of encoding a speech signal and a non-speech audio signal, comprising:
speech-encoding an input signal;
speech-decoding the speech-encoded signal; and
dividing a difference signal between the speech-decoded signal and the input signal into a low band and a high band, allocating the number of bits to the divided bands, respectively, and audio-encoding the difference signal.

10. The method of claim 9, wherein the dividing of the difference signal comprises:
converting the difference signal into a predetermined number of signals having sub-bands in the frequency domain;
calculating masking thresholds of the sub-bands of the converted signals;
grouping the converted signals into the low band and the high band and allocating a low-band bit number and a high-band bit number to the low band and the high band, respectively;
quantizing the converted signals according to the low-band bit number and the high-band bit number; and
encoding the quantized signals.

11. The method of claim 10, wherein the low-band bit number is calculated using the following equation
B_{LB}=B_{T}×T_{LB}/(T_{LB}+T_{HB}), and
wherein, B_{LB} denotes the low-band bit number, B_{T} denotes a total bit number allocated to the entire band, T_{LB} denotes an average value of the masking thresholds of the sub-bands included in the low band, and T_{HB} denotes an average value of the masking thresholds of the sub-bands included in the high band.

12. The method of claim 11, wherein, in the grouping of the converted signals, the bit number are allocated to the sub-bands included in the low band in the range of the low-band bit number using corresponding thresholds.

13. The method of claim 10, wherein the high-band bit number is calculated using the following equation
B_{HB}=B_{T}×T_{HB}/(T_{LB}+T_{HB}), and
wherein, B_{HB} denotes the high-band bit number, B_{T} denotes a total bit number allocated to the entire band, T_{LB} denotes an average value of the masking thresholds of the sub-bands included in the low band, and T_{HB} denotes an average value of the masking thresholds of the sub-bands included in the high band.

14. The method of claim 13, wherein, in the grouping of the converted signals, the number of bits are allocated to the sub-bands included in the high band in the range of the high-band bit number using corresponding thresholds.

15. A computer-readable medium having embodied thereon a computer program for performing the method of claim 9.

16. A method of decoding a speech signal and a non-speech audio signal, comprising:
audio-decoding audio-encoded signals to which the number of bits are allocated according to a low band and high band; and
speech-decoding a speech-encoded signal.

17. The method of claim 16, wherein the audio-decoding of the audio-encoded signals comprises:
decoding the audio-encoded signals;
inversely quantizing the decoded audio signals according to a low-band bit number allocated to a low band and a high-band bit number allocated to a high band; and
converting the inversely quantized audio signals into an audio signal of a time domain.

18. A computer-readable medium having embodied thereon a computer program for performing the method of claim 16.

19. A device for encoding a speech signal and a non-speech audio signal, comprising:
an audio encoding unit which divides a difference signal between an input signal and a speech-decoded signal into a low band and a high band, allocates the number of bits to the divided bands, and audio-encodes the difference signal,
wherein the speech-decoded signal is a decoded speech-encoded signal, and the speech-encoded signal is a speech-encoded version of the input signal.

20. The device of claim 19, wherein the audio encoding unit comprises:
a sub-band analysis filter which converts the difference signal into a predetermined number of signals having sub-bands in a frequency domain;
a psychoacoustic model unit which calculates masking thresholds of the sub-bands of the converted signals;
a bit number allocating unit which groups the converted signals into the low band and the high band and allocates a low-band bit number and a high-band bit number to the low band and the high band, respectively, the allocated band bit numbers being bit numbers for encoding the respective band signals;
a quantizing unit which quantizes the converted signals according to the low-band bit number and the high-band bit number; and
an entropy encoding unit which encodes the quantized signals.

21. The device of claim 20, wherein a masking thresholds are limit values which is usable to detect an original sound from a curve of an original sound and a minimum audible limit in psychoacoustic encoding.

22. The device of claim 20, wherein the average value of the masking thresholds of the sub-bands included in the low band is obtained by averaging the masking thresholds of the sub-bands included in the low band among masking thresholds calculated by the psychoacoustic model unit, and
wherein the average value of the masking thresholds of the sub-bands included in the high band is obtained by averaging the masking thresholds of the sub-bands included in the high band among the masking thresholds calculated by psychoacoustic model unit.

23. The device of claim 20, wherein the bit number allocating unit allocates a higher bit number to the high band than to the low band when the input signal is a speech signal, and allocates a higher bit number to the low band than to the high band when the input signal is a non-speech audio signal.

24. The device of claim 20, wherein the bit number allocating unit allocates the number of bits to the sub-bands using corresponding thresholds obtained by the psychoacoustic model unit.
